(19) United States
(12) Patent Application Publication
(10) Pub. No.: US 2005/0088797 A1
(43) Pub. Date: Apr. 28, 2005

(54) Multi-stage DC/AC coupled impact force enhancing device of a electric nailer

(76) Inventor: Chao-Cheng Lu, Taipei (TW)

Correspondence Address: CHARLES E. BAXLEY, ESQ., 90 JOHN STREET, THIRD FLOOR, NEW YORK, NY, 10038, US

(21) Appl. No.: 10/693,124

(22) Filed: Oct. 24, 2003

(51) Int. Cl. B25C 1/00

(52) U.S. Cl. 361/160

(57) ABSTRACT

A multi-stage DC/AC coupled impact force enhancing device of an electric nailer includes an AC power source, a half-wave rectifying circuit, a doubler rectifying filter circuit, a DC steady-state circuit, an AC phase sampling circuit, a phase start circuit, a switch start circuit, an impulse oscillation circuit, a decoding counting circuit, an energy-storage circuit, a solid-state switch circuit, and an electromagnetic coil. Thus, the multi-stage DC/AC coupled impact force enhancing device can couple the alternating/direct current voltage to serially discharge the voltage to the electromagnetic coil of the electric nailer in a short period of time, thereby generating a larger impact force.

### BACKGROUND OF THE INVENTION

1. Field of the Invention

The present invention relates to a multi-stage DC/AC coupled impact force enhancing device of an electric nailer, and more particularly to a multi-stage DC/AC coupled impact force enhancing device of an electric nailer, wherein the multi-stage DC/AC coupled impact force enhancing device can couple the alternating/direct current voltage to serially discharge the voltage to the electromagnetic coil of the electric nailer in a short period of time, thereby generating a larger impact force.

2. Description of the Related Art

A conventional electric nailer uses the principle of the rectifying filter circuit to transform the alternating current (AC) power source into multiple times direct current (DC) voltage, so as to charge a single electrolytic capacitor which discharges the power to the electromagnetic coil, thereby obtaining the impact force. However, the impact force cannot provide an evenly distributed work required for the impact track of the conventional electric nailer. Thus, it is necessary to increase the capacitance to generate the required impact force, thereby increasing the volume, the weight and costs of fabrication.

### SUMMARY OF THE INVENTION

The present invention is to mitigate and/or obviate the disadvantage of the conventional electric nailer.

The primary objective of the present invention is to provide a multi-stage DC/AC coupled impact force enhancing device of an electric nailer which is applied in multi-stage capacitor energy storage. The multi-stage DC/AC coupled impact force enhancing device can couple the alternating/direct current voltage to serially discharge the voltage to the electromagnetic coil of the electric nailer in a short period of time, thereby generating a larger impact force.

In accordance with the present invention, there is provided a multi-stage DC/AC coupled impact force enhancing device of an electric nailer, comprising an AC power source, a half-wave rectifying circuit, a doubler rectifying filter circuit, a DC steady-state circuit, an AC phase sampling circuit, a phase start circuit, a switch start circuit, an impulse oscillation circuit, a decoding counting circuit, an energy-storage circuit, a solid-state switch circuit, and an electromagnetic coil.

The multi-stage DC/AC coupled impact force enhancing device applies a half-wave rectifying circuit principle to transform the voltage from the AC power source into a positive direction AC voltage which is coupled with a multi-stage capacitor energy-storage and solid-state switch circuit and is output from a final stage of the multi-stage capacitor energy-storage and solid-state switch circuit to discharge the voltage to the electromagnetic coil, thereby generating an enhanced impact force.

In addition, the multi-stage DC/AC coupled impact force enhancing device applies a doubler circuit to transform the AC voltage into a DC voltage of multiple times, so that the electric energy is stored in the capacitor of each stage. Meanwhile, the AC voltage is transformed by the half-wave rectifying circuit into a positive half-wave voltage, so that the capacitor with sufficient electric energy and positive half-wave voltage can discharge the voltage to the electromagnetic coil of the electric nailer in a short period of time, thereby generating an enhanced impact force.

Further benefits and advantages of the present invention will become apparent after a careful reading of the detailed description with appropriate reference to the accompanying drawings.

### BRIEF DESCRIPTION OF THE DRAWINGS

FIG. 1 is a block view of a multi-stage DC/AC coupled impact force enhancing device of an electric nailer in accordance with the preferred embodiment of the present invention;

FIG. 2 is a circuit diagram of the multi-stage DC/AC coupled impact force enhancing device in accordance with the preferred embodiment of the present invention;

FIG. 3 is a graph showing the waveform of the terminal voltage of the electromagnetic coil of the multi-stage DC/AC coupled impact force enhancing device in accordance with the preferred embodiment of the present invention;

FIG. 4 is a graph showing the waveform of the terminal current of the electromagnetic coil of the multi-stage DC/AC coupled impact force enhancing device in accordance with the preferred embodiment of the present invention; and

FIG. 5 is a graph showing the waveform of the terminal alternating/direct current voltage of the electromagnetic coil of the multi-stage DC/AC coupled impact force enhancing device in accordance with the preferred embodiment of the present invention.

### DETAILED DESCRIPTION OF THE INVENTION

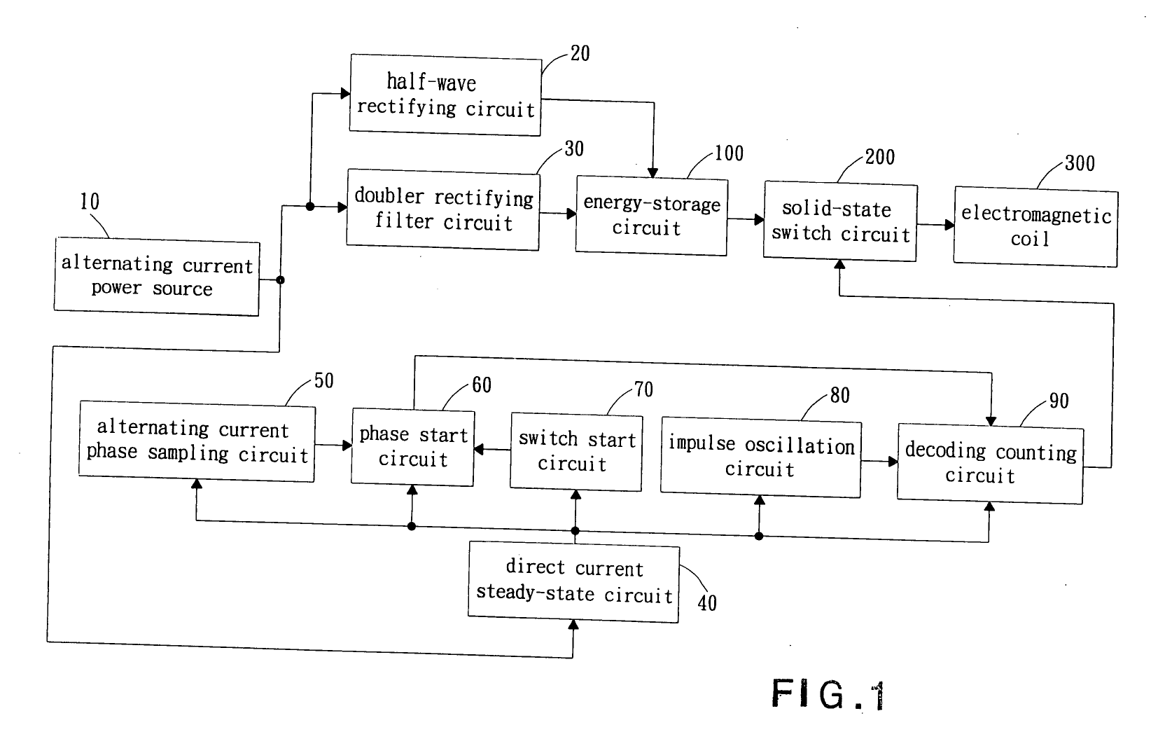

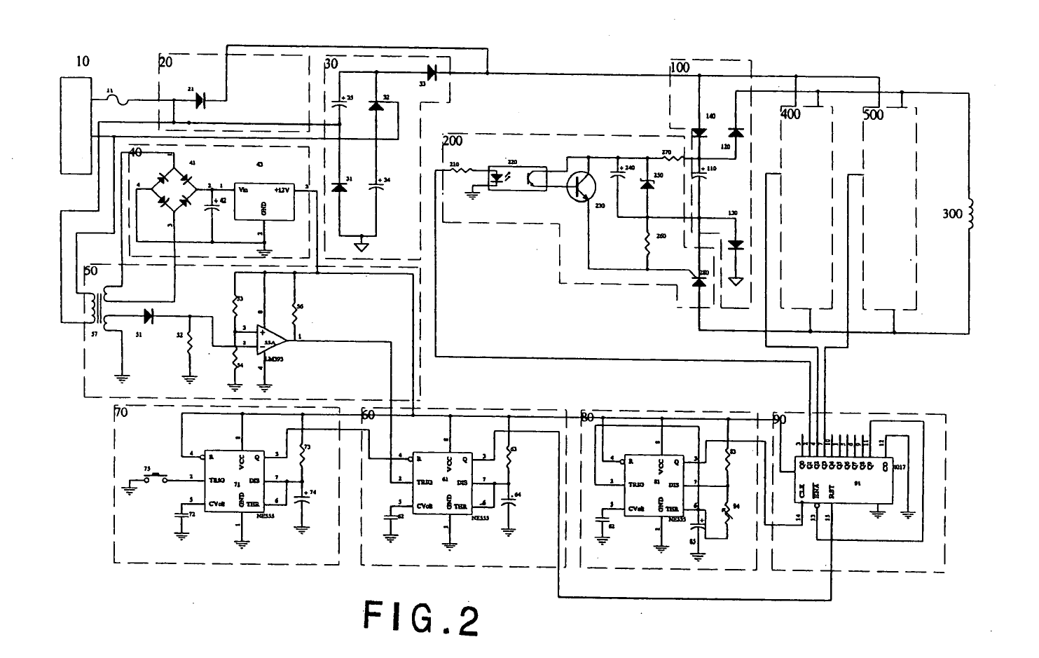

Referring to the drawings and initially to FIGS. 1 and 2, a multi-stage DC/AC coupled impact force enhancing device of an electric nailer in accordance with the preferred embodiment of the present invention comprises an AC power source 10, a half-wave rectifying circuit 20, a doubler rectifying filter circuit 30, a DC steady-state circuit 40, an AC phase sampling circuit 50, a phase start circuit 60, a switch start circuit 70, an impulse oscillation circuit 80, a decoding counting circuit 90, an energy-storage circuit 100, a solid-state switch circuit 200, and an electromagnetic coil 300.

The AC power source 10 includes a fuse 11.

The half-wave rectifying circuit 20 includes a rectifying diode 21.

The doubler rectifying filter circuit 30 includes three rectifying diodes 31, 32 and 33, and two electrolytic capacitors 34 and 35.

The DC steady-state circuit 40 includes a bridge rectifier 41, an electrolytic capacitor 42, and a steady-state IC (7812) 43.

The AC phase sampling circuit 50 includes a half-wave rectifying diode 51, a load resistor 52, two reference resistors 53 and 54, a comparator (IC393) 55, an enhancing resistor 56, and a transformer 57.

The phase start circuit 60 is a single steady-state circuit, and includes a counter (IC555) 61, a capacitor 62, a time constant variable resistor 63, and a time constant capacitor 64.

The switch start circuit 70 is a single steady-state circuit, and includes a counter (IC555) 71, a capacitor 72, a time constant resistor 73, and a time constant capacitor 74, and a start switch 75.

The impulse oscillation circuit 80 includes a counter (IC555) 81, a capacitor 82, a time constant resistor 83, a time constant variable resistor 84, and a time constant capacitor 85.

The decoding counting circuit 90 includes a decoding counter (IC4017) 91.

The energy-storage circuit 100 includes an electrolytic capacitor 110, and three diodes 120, 130 and 140.

The solid-state switch circuit 200 includes a current limited resistor 210, a photo-electric coupler transistor 220, a NPN transistor 230, an electrolytic capacitor 240, a zener diode 250, a gate resistor 260, a resistor 270, and a silicon control rectifier 280.

Referring to FIG. 2, when the start switch 75 of the switch start circuit 70 is disposed at the “ON” state, the single steady-state period of the counter (IC555) 71 of the switch start circuit 70 is 1.1*R73*C74. When the counter (IC555) 61 is triggered, its output is disposed at the “Hi” state. At this time, the “RESET” of the counter (IC555) 61 is also disposed at the “Hi” state, so that it can be operated, to wait for being triggered by the AC phase sampling circuit 50. The voltage of the phase start circuit 60 is dropped by the secondary of the transformer 57, and is passed through the half-wave rectifying diode 51 to obtain the positive-direction AC voltage signal which is input into the negative terminal of the comparator (IC393) 55. Then, the DC steady-state circuit 40 supplies partial voltage to the two reference resistors 53 and 54 to obtain a reference voltage which is input into the positive terminal of the comparator (IC393) 55.

When the AC voltage at the negative terminal of the comparator (IC393) 55 is greater than the reference voltage at the positive terminal of the comparator (IC393) 55, the output terminal is disposed at the “Low” state. At this time, the phase angle of the AC power source 10 is ten degrees. At the same time, the counter (IC555) 61 of the phase start circuit 60 is also triggered. The single steady-state period of the counter (IC555) 61 of the phase start circuit 60 is 1.1*R63*C64. When the counter (IC555) 61 is triggered, its output is disposed at the “Hi” state.

When the time constant variable resistor 63 of the phase start circuit 60 is adjusted to change the single steady-state period of the counter (IC555) 61 to transform its output into the “Low” state, the “CLEAR” of the decoding counter (IC4017) 91 is disposed at the “Low” state, the “CLOCK” starts to input, and the output terminals Q0 to Q9 output successively.

When the “CLEAR” of the decoding counter (IC4017) 91 is disposed at the “Low” state, the “CLOCK” begins to input, and the output terminals Q0 to Q9 output successively and are disposed at the “Hi” state. When the output terminal Q9 is disposed at the “Hi” state, the “CLOCK ENABLE” is also disposed at the “Hi” state. At this time, the “CLOCK” stops input, and waits the “CLEAR” to transform the state at the next time, so as to decode, count and output again.

The “CLOCK” of the decoding counter (IC4017) 91 is supplied by the counter (IC555) 81 of the impulse oscillation circuit 80. The high-state time tH of the counter (IC555) 81 is 0.693*(R83+R84)*C85, and the low-state time tL of the counter (IC555) 81 is 0.693*R84*C85. The R84 adopts the variable resistor to adjust the frequency of the unsteady-state impulse oscillation circuit 80, so as to provide the required frequency.

The capacitor energy-storage device of the present invention applies the doubler rectifying filter circuit 30 to transform the voltage of the AC power source 10 into a three times DC voltage.

The doubler rectifying filter circuit 30 consists of the three rectifying diodes 31, 32 and 33, the two electrolytic capacitors 34 and 35, and the electrolytic capacitor 110 in the energy-storage circuits 100 of each stage. The doubler rectifying filter circuit 30 can transform the voltage of the AC power source 10 into the three times DC voltage. The electrolytic capacitor 110 forms the third time voltage, to function as an energy-storage capacitor for discharging the voltage to the electromagnetic coil 300. Thus, the doubler rectifying filter circuit 30 is different from the common tripler rectifying circuit.

After the output side of the LED of the photo-electric coupler transistor 220 of the solid-state switch circuit 200 is conducted by the decoding counter (IC4017) 91, the NPN transistor 230 is also conducted, so that the amplified voltage from the doubler rectifying filter circuit 30 passes through the resistor 270 and the zener diode 250 to the electrolytic capacitor 110 to trigger the gate of the silicon control rectifier 280, so that the anode and the cathode of the silicon control rectifier 280 are conducted. At the same time, the electric energy of the electrolytic capacitor 110 passes through the diode 120 to the electromagnetic coil 300, and is conducted to the diode 130, thereby forming the energy-storage circuit 100. Thus, the energy-storage circuit 100 and the solid-state switch circuit 200 form a first capacitor energy-storage and solid-state switch circuit to discharge the voltage to the electromagnetic coil 300.

Similarly, the multi-stage DC/AC coupled impact enhancing device further comprises a second capacitor energy-storage and solid-state switch circuit 400 including the energy-storage circuit 100 and the solid-state switch circuit 200 to discharge the voltage to the electromagnetic coil 300.

In addition, the multi-stage DC/AC coupled impact enhancing device further comprises a third capacitor energy-storage and solid-state switch circuit 500 including the energy-storage circuit 100 and the solid-state switch circuit 200 to discharge the voltage to the electromagnetic coil 300.

Thus, the multiple capacitor energy-storage and solid-state switch circuits can couple the voltage from the AC power source 10 through the rectifying diode 21 of the half-wave rectifying circuit 20 to discharge the voltage to the electromagnetic coil 300, wherein the amplitude of the positive direction AC voltage is about 90 to 180 degrees. In addition, the multi-stage discharging energy can couple the single positive phase AC power source 10, so that the electromagnetic coil 300 can produce an enhanced impact force.

Accordingly, the multi-stage DC/AC coupled impact enhancing device generates a multi-stage discharging energy, so that the electromagnetic coil 300 can generate an enhanced impact force. In practice, the multi-stage DC/AC coupled impact enhancing device uses the doubler rectifying filter circuit 30 to transform the voltage of the AC power source 10 into the three times DC voltage, and to charge the electrolytic capacitor 110 of each stage. Thus, the multi-stage DC/AC coupled impact enhancing device has a sufficient electric energy to serially discharge the voltage to the electromagnetic coil 300 of the electric nailer in a short period of time, thereby producing a larger impact force.

In conclusion, the multi-stage DC/AC coupled impact enhancing device uses a multi-stage electrolytic capacitor to charge and store the electric energy which generates an impact force to discharge the voltage to the electromagnetic coil of the electric nailer, while the AC voltage is transformed by the half-wave rectifying circuit into a positive half-wave AC voltage, so that the electrolytic capacitor with the sufficient electric energy and the positive half-wave AC voltage can discharge the voltage to the electromagnetic coil of the electric nailer in a short period of time, thereby producing an enhanced impact force.

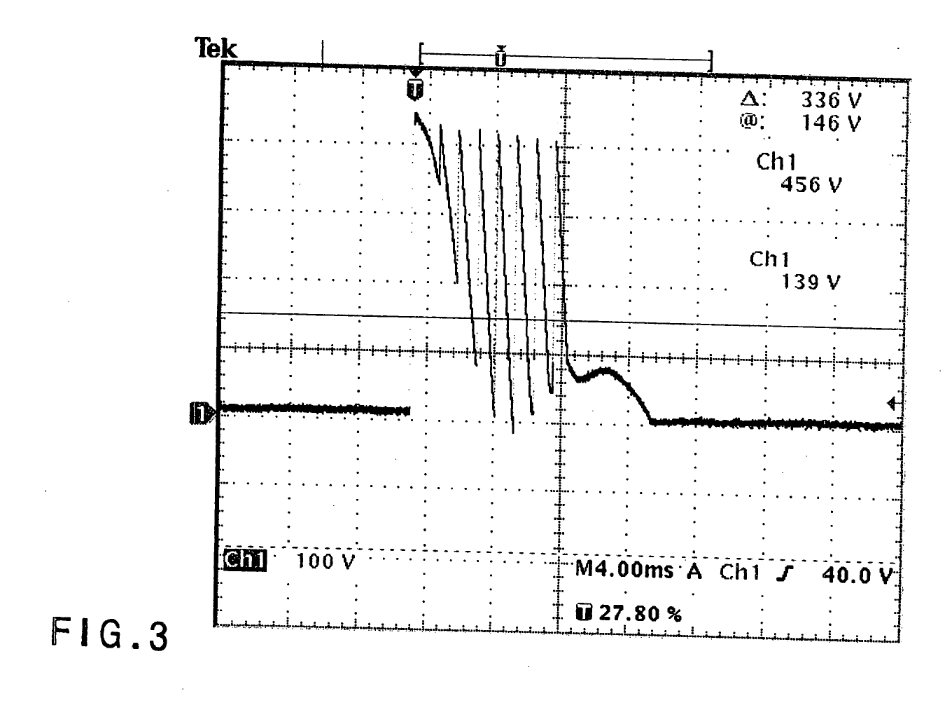

FIG. 3 is a graph showing the waveform of the terminal voltage of the electromagnetic coil 300 of the multi-stage DC/AC coupled impact force enhancing device in accordance with the preferred embodiment of the present invention.

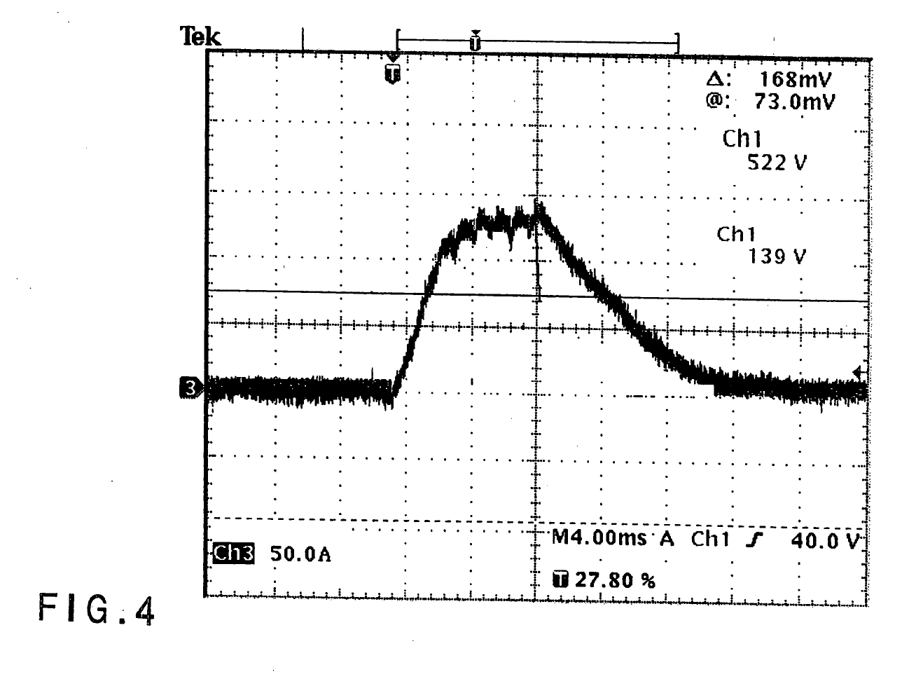

FIG. 4 is a graph showing the waveform of the terminal current of the electromagnetic coil 300 of the multi-stage DC/AC coupled impact force enhancing device in accordance with the preferred embodiment of the present invention.

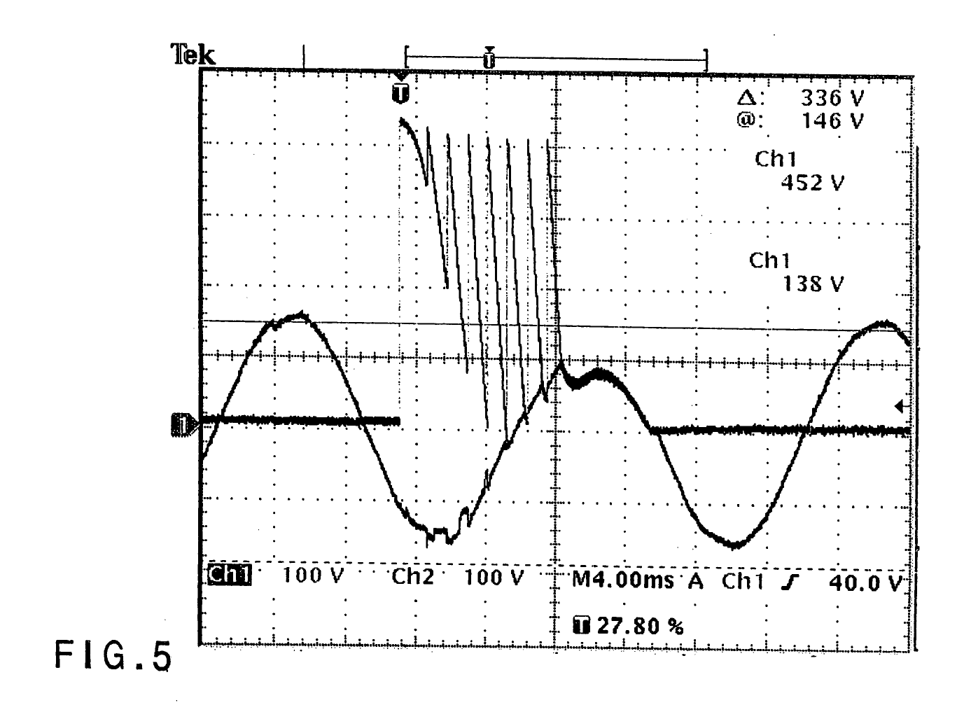

FIG. 5 is a graph showing the coupled waveform of the terminal alternating/direct current voltage of the electromagnetic coil 300 of the multi-stage DC/AC coupled impact force enhancing device in accordance with the preferred embodiment of the present invention.

While the preferred embodiment(s) of the present invention has been shown and described, it will be apparent to those skilled in the art that various modifications may be made in the embodiment(s) without departing from the spirit of the present invention. Such modifications are all within the scope of the present invention.

1. A multi-stage DC/AC coupled impact force enhancing device of an electric nailer, comprising an AC power source, a half-wave rectifying circuit, a doubler rectifying filter circuit, a DC steady-state circuit, an AC phase sampling circuit, a phase start circuit, a switch start circuit, an impulse oscillation circuit, a decoding counting circuit, an energy-storage circuit, a solid-state switch circuit, and an electromagnetic coil.

2. The multi-stage DC/AC coupled impact force enhancing device of an electric nailer in accordance with claim 1, wherein the multi-stage DC/AC coupled impact force enhancing device applies a half-wave rectifying circuit principle to transform the voltage from the AC power source into a positive direction AC voltage which is coupled with a multi-stage capacitor energy-storage and solid-state switch circuit and is output from a final stage of the multi-stage capacitor energy-storage and solid-state switch circuit to discharge the voltage to the electromagnetic coil, thereby generating an enhanced impact force.

3. The multi-stage DC/AC coupled impact force enhancing device of an electric nailer in accordance with claim 2, wherein the amplitude of the positive direction AC voltage is about 90 to 180 degrees.
